(19) United States
(12) Patent Application Publication
(10) Pub. No.: US 2017/0329053 A1
(43) Pub. Date: Nov. 16, 2017

(54) MATERIAL WITH HIGH OXYGEN PERMEABILITY BASED ON MARINE BIOLOGICAL SUBSTANCE, PREPARATION METHOD AND USE THEREOF

(71) Applicant: QINGDAO CHUNGHAO TISSUE ENGINEERING CO.,LTD., Qingdao City (CN)

(72) Inventors: Baoquan WANG, Anqiu City (CN); Qing LI, Qingdao City (CN)

(73) Assignee: QINGDAO CHUNGHAO TISSUE ENGINEERING CO.,LTD., Qingdao City (CN)

(21) Appl. No.: 15/535,311

(22) PCT Filed: May 29, 2015
(86) PCT No.: PCT/CN2015/080218

§ 371 Date: Jun. 12, 2017

(30) Foreign Application Priority Data
Dec. 12, 2014 (CN) 201410766381.4

(51) Int. Cl. G02B 1/04; C08L 5/08; C08L 5/04; C08K 5/544; C08K 5/5419; G02C 7/04; C08J 3/24

(52) U.S. Cl. CPC G02B 1/043; G02C 7/04; C08L 5/08; C08J 3/24; C08K 5/544; C08K 5/5419; C08L 5/04

(57) ABSTRACT

A material with high oxygen permeability based on marine biological substance is disclosed. The material is obtained by compounding a silicon-containing substance with a silicon-oxy group and a bioactive substance selected from one or more of alginic acid, collagen, hyaluronic acid and a salt thereof, in the presence of a crosslinking agent. Also disclosed is a preparation method for the material including: mixing the silicon-containing substance and bioactive substance under acidic condition, and then crosslinking the mixture in the presence of a crosslinking agent. Also disclosed is a use of the material with high oxygen permeability or method thereof to prepare a corneal contact lens, corneal scaffold material, or corneal substitute. The material can satisfy the requirement of high oxygen permeability for extended wear and shows good wearing comfort. The material is biocompatible and has high safety performance.

### FIELD OF THE INVENTION

The present invention belongs to the field of medical equipment, in particular, involves a material with high oxygen permeability based on marine biological substance, preparation method and use thereof.

### BACKGROUND OF THE INVENTION

Corneal contact lens (hereinafter referred to as contact lens) is a kind of delicate ophthalmic medical instrument, the main purpose is to correct vision, keep natural appearance, medical treatment, et al. The oxygen permeability coefficient (DK) or oxygen transfer coefficient (DK/t) is commonly used to state the oxygen permeation ability of corneal contact lens, wherein D is the diffusion coefficient of O₂ in the material, K is the dissolving coefficient of O₂ in the material, DK is the product of D and K, the unit of which is banner, and t is the center thickness of the lens, the unit of which is millimetres (mm). Researcher suggests that, to meet the day wear requirements of no corneal edema, DK/t value must be greater than 24 banrrers/mm. When wear overnight, DK/t value must be greater than 87 banrrers/mm, but corneal edema still occur in a rate of 4%. Only when DK/t>125 banrrers/mm, it can ensure that extended wear will not result in relative symptoms caused by a lack of oxygen. Wearers can wear contact lens for consecutive seven days, 30 days or longer, which can reduce the trouble caused by wearing for everyday and provide the possibility for the treatment of slow release and controlled release of drugs etc. in the eye. The oxygen permeation ability is the primary factor to determine that whether the lens is suitable for daily wear or extended wear, and the majority of consumers will consider that whether the lens is suitable for extended wear, when they choose contact lens. Therefore, cornea contact lens with high oxygen permeability has a large market demand. Now, DK/t value of the common hydrogel contact lens remains to be improved.

### SUMMARY OF THE INVENTION

The purpose of the present invention is to overcome poor oxygen permeability and other defects in the existing corneal contact lens, and provide a material with high oxygen permeability based on marine biological substance, preparation method and use thereof.

In order to obtain corneal contact lens with high oxygen permeability and good comfort, the inventors of the present invention did a lot of experiments. It was found that cornea contact lens which is prepared by using marine biological substances such as alginic acid and silicon-containing substances with silicon-oxy groups as raw materials showed better oxygen permeability and comfort. Therefore, in the first aspect, the present invention provides a material with high oxygen permeability which is obtained by compounding a silicon-containing substance with silicon-oxy group and a bioactive substance selected from one or more of alginic acid, collagen, hyaluronic acid and salts thereof.

In the second aspect, the present invention provides a preparation method of the material with high oxygen permeability, which includes: the silicon-containing substance and bioactive substance are mixed under acidic condition, then the mixture is subjected to crosslinking reaction in the presence of a crosslinking agent.

The preferable method of the present invention includes the following steps:

(1) a silicon-containing substance dispersed in an acid solution containing 10⁻³-10⁻⁶mol/L of hydrogen ion and a bioactive substance are mixed, in which the silicon-containing substance is selected from at least one of silica gel, 3-aminopropyl trimethoxysilane, tetraethoxy-silicone and diethoxydimethylsilane, the particle size of silica gel is preferably 200-800 meshes, the bioactive substance is selected from at least one of alginic acid, sodium alginate, potassium alginate, collagen, hyaluronic acid, sodium hyaluronate and potassium hyaluronate.

(2) the mixture obtained in step (1) is subjected to crosslinking reaction for 2-5 h at 15-35° C. in the presence of a crosslinking agent.

wherein based on 100 parts by weight of the bioactive substance, the amount of silicon-containing substance is 1-10 parts by weight and the amount of crosslinking agent is 0.01-5 parts by weight.

In the third aspect, the present invention provides a material with high oxygen permeability prepared by the method according to the second aspect.

In the fourth aspect, the present invention provides use of the material with high oxygen permeability according to the first aspect or third aspect, or the method according to the second aspect in preparation of corneal contact lens, corneal scaffold material or corneal substitute.

Through the above technical solution, the present invention obtained a material with high oxygen permeability that can satisfy the requirement of high oxygen permeability for extended wear and show good wearing comfort (high water content). It has important practical significance and broad application prospects for the development of long-term wearing corneal contact lens and slow and controlled release of therapeutic preparation for corneal disease. Furthermore, the employing of marine biological substance (alginic acid, collagen, hyaluronic acid and their salts) with good biocompatibility makes the material with high oxygen permeability have good biocompatibility and high safety performance

Other characteristics and advantages of the present invention will be described in details in the subsequent embodiments.

### DETAILED DESCRIPTION OF THE EMBODIMENTS

Below the embodiments of the present invention are described. It should be understood that the embodiments described here are intended to illustrate and not to limit the present invention.

The material with high oxygen permeability provided in the present invention is obtained by compounding a silicon-containing substance with silicon-oxy group and a bioactive substance selected from one or more of alginic acid, collagen, hyaluronic acid, and salts thereof, in the presence of a crosslinking agent. Wherein crosslinking is present among at least part of (or all of) the bioactive substances.

According to the present invention, there's no special requirements for the amount of silicon-containing substance and bioactive substance. Based on the 100 parts by weight of the bioactive substance, the amount of silicon-containing substance is preferably 1-10 parts by weight.

According to the present invention, the collagen can be various common collagen which is derived from mammals etc. Preferably, the collagen is derived from fish. More preferably, the collagen has a molecular weight of 8-350 kDa. Most preferably, the collagen is type I collagen.

According to the present invention, the molecular weight of hyaluronic acid is preferably 80-2000 kDa.

In the present invention, the salt of alginic acid, collagen or hyaluronic acid can also be used to obtain the material with high oxygen permeability in the present invention. Preferably, the bioactive substance is selected from at least one of alginic acid, sodium alginate, potassium alginate, collagen, hyaluronic acid, sodium hyaluronate and potassium hyaluronate.

According to the present invention, the silicon-containing substance can be the silicon-containing substance with silica group commonly used for the preparation of corneal contact lens in the field. Preferably, the silicon-containing substance is selected from at least one of silica gel, 3-aminopropyl trimethoxysilane, tetraethoxy-silicone and diethoxydimethylsilane. The particle size of silica gel is preferably 200-800 meshes.

According to the embodiment of the present invention, the material with high oxygen permeability is obtained by compounding a silicon-containing substance and a bioactive substance in the presence of a crosslinking agent. Based on 100 parts by weight of the bioactive substance, the amount of crosslinking agent is preferably 0.01-5 parts by weight, more preferably 0.1-3 parts by weight. The crosslinking agent may be any commonly used matter making the bioactive substance crosslinked in the field. Preferably, the crosslinking agent is CaCl₂, and/or a mixture of 1-ethyl-3-(3-dimethylaminopropyl)-carbodiimide and N-hydroxysuccinimide (EDC/NHS, the molar ratio of EDC/NHS is usually 1:0.1-2).

The method for preparing the material with high oxygen permeability in the present invention includes: the silicon-containing substance and bioactive substance are mixed under acidic condition, and the mixture is subjected to crosslinking reaction in the presence of a crosslinking agent.

According to the present invention, there's no special requirements for the amount of silicon-containing substance and bioactive substance. And the amount of silicon-containing substance is preferably 1-10 parts by weight, based on 100 parts by weight of bioactive substance.

According to the present invention, the collagen can be various common collagen which is derived from mammals etc. Preferably, the collagen is derived from fish. More preferably, the collagen has a molecular weight of 8-350 kDa. Most preferably, the collagen is type I collagen. In order to maintain the activity of collagen, when the material with high oxygen permeability is obtained by compounding a collagen and a silicon-containing substance, silicon-containing substance and bioactive substance are mixed at 0-20° C.

According to the present invention, the molecular weight of hyaluronic acid is preferably 80-2000 kDa.

In the present invention, the salt of alginic acid, collagen or hyaluronic acid can also be used to obtain the material with high oxygen permeability in the present invention. Preferably, the bioactive substance is selected from at least one of alginic acid, sodium alginate, potassium alginate, collagen, hyaluronic acid, sodium hyaluronate and potassium hyaluronate.

According to the present invention, the silicon-containing substance may be the silicon-containing substance with silica group commonly used for the preparation of corneal contact lens in the field. Preferably, the silicon-containing substance is selected from at least one of silica gel, 3-aminopropyl trimethoxysilane, tetraethoxy-silicone and diethoxydimethylsilane. The particle size of silica gel is preferably 200-800 meshes.

According to the present invention, based on 100 pans by weight of the bioactive substance, the amount of crosslinking agent is preferably 0.01-5 parts by weight, more preferably 0.1-3 parts by weight. The crosslinking agent may be any commonly used matter making the bioactive substance crosslinked in the field. Preferably, the crosslinking agent is CaCl₂, and/or a mixture of 1-ethyl-3-(3-dimethylaminopropyl)-carbodiimide and N-hydroxysuccinimide (EDC/NHS, the molar ratio of EDC/NHS is usually 1:0.1-2). The crosslinking agent may be used in form of solution, and the concentration of crosslinking agent in the solution may be 0.05-3 mol/L.

Preferably, the acidic condition manifests pH 3-6.

According to the preferred embodiment of the present invention, before mixing the silicon-containing substance and bioactive substance, the silicon-containing substance is dispersed in an acid solution containing 10⁻³-10⁻⁶ mol/L of hydrogen ion. Per mole (gram) silicon-containing substance is generally dispersed in 0.2-10 L (or 0.2-5 L) acid solution. Dispersing may be carried out in a conventional manner, as long as the silicon-containing substance is dispersed fully, thus facilitate the subsequent step of crosslinking For example, ultrasonic dispersion may be adopted (the frequency for ultrasonic dispersion may be 35-50 kHz, the time for ultrasonic dispersion may be 15-30min). When the silicon-containing substance is silica gel, it may be purified in order to obtain a material with high oxygen permeability manifesting better comfort and light-admitting quality. The methods of purification may be any method known in the field. More preferably, the method further includes: before being dispersed in an acid solution, the silicon-containing substance is treated as follows (to purify the silica gel):
(a) the silicon-containing substance is dealt with acid liquid for 2-10 h at 50-100° C., and then washed with water until become neutral:
(b) the silicon-containing substance processed by step (1) is immersed in a mixed solution of hydrochloric acid solution and ethanol for 2-10 h at 20-50° C., and then washed with water until become neutral;

In step (a), the concentration of hydrogen ion in the acid liquid is preferably 1-10 mol/L. The preferable acid contained in the acid liquid is at least one of sulfuric acid, nitric acid and hydrochloric acid.

In the mixture of hydrochloric acid solution and ethanol mentioned in step (b), the concentration of hydrogen ion in the hydrochloric acid solution is 0.005-0.05 mol/L, and the volume ratio of hydrochloric acid solution and ethanol is 1:0.1-5.

In the present invention, the acid contained in the acid solution is at least one of acetic acid, sulfuric acid, nitric acid and hydrochloric acid. The acid contained in the acid solution, the acid contained in the acid liquid used in step (a) and the acid used in step (b) may be the same or different.

According to the present invention, there's no special requirements for the condition for crosslinking reaction, as long as the bioactive substance is crosslinked. Preferably, the condition for crosslinking reaction includes: a temperature of 15-35° C. and a time of 2-5 h.

According to the present invention, the method may further include: before crosslinking reaction, bubbles are removed from the mixture. The method of removing bubbles may be centrifugation or vacuum-pumping, which can be selected by the skilled in the art, and need not be repeated here.

According to a preferred embodiment of the present invention, the method for preparing the material with high oxygen permeability includes the following steps:

(1) a silicon-containing substance dispersed in an acid solution containing 10⁻³-10⁻⁶ mol/L of hydrogen ion and a bioactive substance are mixed, in which the silicon-containing substance is selected from at least one of silica gel, 3-aminopropyl trimethoxysilane, tetraethoxsilicone and diethoxydimethyl-silane, the particle size of silica gel is 200-800 meshes, the bioactive substance is selected from at least one of alginic acid, sodium alginate, potassium alginate, collagen, hyaluronic acid, sodium hyaluronate and potassium hyaluronate.

(2) the mixture obtained in step (1) is subjected to crosslinking reaction for 2-5 h at 15-35° C. in the presence of a crosslinking agent;

wherein based on 100 parts by weight of the bioactive substance, the amount of silicon-containing substance is 1-10 parts by weight and the amount of crosslinking agent is 0.01-5 parts by weight.

In the present invention, the bioactive substance may be mixed with the silicon-containing substance in the form of solution, and the concentration of bioactive substance in the solution may be 5-200 mg/mL, for example, the concentration of alginic acid or salts thereof may be 10-200 mg/mL; the concentration of collagen or salts thereof may be 5-50 mg/mL; the concentration of hyaluronic acid or salts thereof may be 10-40 mg/mL.

The silicon-containing substance and bioactive substance used in the present invention can be obtained by chemical synthesis methods or may be commercially available and need not be repeated here.

The present invention also provided the material with high oxygen permeability obtained by the above-mentioned method.

Furthermore, the present invention also provides use of the above-mentioned method or the material with high oxygen permeability in preparation of corneal contact lenses, corneal scaffold material or corneal substitute.

When the corneal contact lenses, corneal scaffold material or corneal substitute is prepared by the above-mentioned method of the present invention, the crosslinking reaction may be carried out in a mould (for corneal contact lenses, corneal scaffold material or corneal substitute) directly. For example, the mixture of silicon-containing substance and bioactive substance is placed in a mould directly, and then the crosslinking agent is added into the mould so as to initiate crosslinking reaction, thus the corneal contact lenses, corneal scaffold material or corneal substitute with specific shape may be obtained.

Below the present invention will be described in details by referring to examples.

In the following examples, the silica gel is purchased from Qingdao Ocean Chemical Co. Ltd; 3-aminopropyl trimethoxysilane is purchased from Sigma; Sodium alginate is purchased from Qingdao Bright Moon Seaweed Limited; fish collagen is isolated from deep-sea cod with molecular weight of 300-350 kDa (i.e. type I collagen); hyaluronic acid is purchased from Solarbio with molecular weight of 80-2000 kDa; EDC (No. 39391) and NHS (No. 130672) are purchased from Sigma; the thickness of the corneal contact lens is measured using corneal pachymeter.

### EXAMPLE 1

(1) The silica gel (300-400 meshes) was treated with concentrated sulfuric acid (98 wt %) for 2 h at 70° C. and washed several times with distilled water until become neutral, and then treated with a mixture of 0.01M hydrochloric acid solution and absolute ethanol (v/v=1:1) for 2 h at 37° C. and washed several times with distilled water until become neutral, then dried at 20° C. for 24 h in reserve.

(2) 0.01g silica gel treated by step (1) was dispersed in 2 mL acetic acid solution (pH 4) ultrasonically (40 kHz) for 20 min and then added into 25 mg/mL of sodium alginate solution (4 mL), vortex mixing thoroughly, removing the bubbles by centrifugation. 300 μL mixed solution was dropped into the contact lens mould, then the contact lens mould was plugged using a plug slowly. 10 μL 0.2 mol/L of CaCl₂ solution was dropped from the gap of the edge followed with gently rotating the plug. The contact lens mould was placed for 2 h at 25° C. and a corneal contact lens with thickness of 100 μm was obtained.

### EXAMPLE 2

(1) The silica gel (800 meshes) was treated with concentrated sulfuric acid (98 wt %) for 5 h at 80° C. and washed several times with distilled water until become neutral, and then treated with a mixture of 0.01M hydrochloric acid solution and absolute ethanol (v/v=1:5) for 2 h at 50° C. and washed several times with distilled water until become neutral, then dried at 20° C. for 24 h in reserve.

(2) 0.008 g silica gel treated by step (1) was dispersed in 2 mL acetic acid solution (pH 6) ultrasonically (40 kHz) for 20 min and then added into 20 mg/mL of fish collagen solution (5 mL), vortex mixing thoroughly, removing the bubbles by centrifugation. 300 μL mixed solution was dropped into the contact lens mould, then the contact lens mould was plugged using a plug slowly. 10 μL 0.05 mol/L of a mixed solution of EDC/NHS was dropped from the gap of the edge followed with gently rotating the plug. The contact lens mould was placed for 4 h at 20° C. and a corneal contact lens with thickness of 100 μm was obtained.

### EXAMPLE 3

(1) 1 mg of 3-aminopropyl trimethoxysilane (ultrasonically dispersed (40 kHz) for 20 min) was dispersed into 3 mL of acetic acid solution (pH 3) at 4° C., and then added into 10 mL of sodium hyaluronate solution (10 mg/mL) and vortex mixing thoroughly in icewater bath for 10 min, removing the bubbles by centrifugation. 100 μL mixed solution was dropped into the contact lens mould, then the contact lens mould was plugged using a plug slowly. 10 μL 1 mol/L of a mixed solution of EDC/NHS was dropped from the gap of the edge followed with gently rotating the plug. The contact lens mould was placed for 5 h at 15° C. and a corneal contact lens with thickness of 100 μm was obtained.

### EXAMPLE 4

Corneal contact lens was prepared according to the method of Example 2, the difference is using the “pig collagen” (with molecular weight of 8-10 kDa) instead of “fish collagen”, and a corneal contact lens with thickness of 100 μm was obtained.

### TEST EXAMPLE 1

Various parameters of corneal contact lenses prepared according to the above methods were measured, such as light transmission rate, oxygen transfer coefficient (DK/t), water content and so on. The specific methods refer to the national standard (GB/T11417.5-2012 and GB/T11417.7-2012), and the results were shown in Table 1.

TABLE 1

| Example | Light transmission | DK/t | Water content |
|---|---|---|---|
| No. | rate (%) | (banners/mm) | (wt %) |
| Example 1 | 95 | 106 | 63 |
| Example 2 | 93 | 129 | 70 |
| Example 3 | 91 | 102 | 52 |
| Example 4 | 87 | 81 | 47 |

As can be seen from the results as shown in Table 1, the material with high oxygen permeability obtained according to the examples had high light transmission rate and oxygen transfer coefficient which satisfied the requirements of an ideal extended wear, and had high water content. Thus, the material with high oxygen permeability of the present invention did have high oxygen permeability, high water content so as to manifest better comfort.

Above preferable embodiments of the present invention are described in details, but the present invention is not limited to the concrete details of the embodiment. Within the scope of technical thinking of the present invention, the technical scheme of the present invention may be modified in a simple way. These simple modifications all are within the protective scope of the present invention.

Further, it should be noted that the technical features described in the foregoing embodiment may be combined in any appropriate way as long as no conflict is aroused. In order to avoid unnecessary repetition, the present invention does not describe all the possible combinations.

Further, the embodiments of the present invention may also be freely combined. As long as they are not against the principle of the present invention, they shall also be deemed as the content disclosed by the present invention.

1. A material with oxygen permeability obtained by compounding a silicon-containing substance with silicon-oxy group and a bioactive substance selected from one or more of alginic acid, collagen, hyaluronic acid, and salts thereof, in the presence of a crosslinking agent.

2. The material with oxygen permeability according to claim 1, wherein based on 100 parts by weight of the bioactive substance, the amount of silicon-containing substance is 1-10 parts by weight.

3. The material with oxygen permeability according to claim 1, wherein the molecular weight of collagen is 8-350 kDa.

4. The material with oxygen permeability according to claim 1, wherein the molecular weight of hyaluronic acid is 80-2000 kDa.

5. The material with oxygen permeability according to claim 1, wherein the silicon-containing substance is selected from at least one of silica gel, 3-aminopropyl trimethoxysilane, tetraethoxy-silicone and diethoxydimethylsilane, and the particle size of silica gel is 200-800 meshes.

6. The material with oxygen permeability according to claim 1, wherein based on 100 parts by weight of the bioactive substance, the amount of crosslinking agent is 0.01-5 parts by weight.

7. The material with oxygen permeability according to claim 1, wherein the crosslinking agent is calcium chloride, and/or a mixture of 1-ethyl-3-(3-dimethyl aminopropyl) carbodiimide and N-hydroxysuccinimide.

8. A method for preparing the material with oxygen permeability, including: a silicon-containing substance with silicon-oxy group and a bioactive substance are mixed under acidic condition, and then the mixture is subjected to crosslinking reaction in the presence of a crosslinking agent, wherein the bioactive substance is selected from one or more of alginic acid, collagen, hyaluronic acid, and salts thereof.

9. The method according to claim 8, wherein the acidic condition includes pH 3-6.

10. The method according to claim 8, wherein before mixing the silicon-containing substance and bioactive substance, the silicon-containing substance is dispersed in an acid solution containing 10⁻³-10⁻⁶ mol/L of hydrogen ion.

11. The method according to claim 10, wherein the silicon-containing substance is silica gel and the method further includes: before being dispersed in an acid solution, the silicon-containing substance is treated as follows:
(a) the silicon-containing substance is dealt with acid liquid for 2-10 h at 50-100° C., and then washed with water until become neutral;
(b) the silicon-containing substance processed by step (1) is immersed in a mixed solution of hydrochloric acid solution and ethanol for 2-10 h at 20-50° C., and then washed with water until become neutral.

12. The method according to claim 10, wherein the acid contained in the acid solution is at least one of acetic acid, sulfuric acid, nitric acid and hydrochloric acid.

13. The method according to claim 8, wherein the condition for crosslinking reaction includes: a temperature of 15-35° C. and a time of 2-5 h.

14. A method for preparing the material with oxygen permeability according to claim 1, including the following steps:
(1) a silicon-containing substance dispersed in an acid solution containing 10⁻³-10⁻⁶ mol/L of hydrogen ion and a bioactive substance are mixed, in which the silicon-containing substance is selected from at least one of silica gel, 3-aminopropyl trimethoxysilane, tetraethoxy-silicone and diethoxydimethylsilane, the particle size of silica gel is 200-800 meshes, the bioactive substance is selected from at least one of alginic acid, sodium alginate, potassium alginate, collagen, hyaluronic acid, sodium hyaluronate and potassium hyaluronate;
(2) the mixture obtained in step (1) is subjected to crosslinking reaction for 2-5 h at 15-35° C. in the presence of a crosslinking agent;
wherein based on 100 parts by weight of the bioactive substance, the amount of silicon-containing substance is 1-10 parts by weight and the amount of crosslinking agent is 0.01-5 parts by weight.

15. (canceled)

16. (canceled)

17. The method according to claim 8, wherein based on 100 parts by weight of the bioactive substance, the amount of silicon-containing substance is 1-10 parts by weight.

18. The method according to claim 8, wherein the molecular weight of collagen is 8-350 kDa.

19. The method according to claim 8, wherein the molecular weight of hyaluronic acid is 80-2000 kDa.

20. The method according to claim 8, wherein the silicon-containing substance is selected from at least one of silica gel, 3-aminopropyl trimethoxysilane, tetraethoxy-silicone and diethoxydimethylsilane, and the particle size of silica gel is 200-800 meshes.

21. The method according to claim 8, wherein based on 100 parts by weight of the bioactive substance, the amount of crosslinking agent is 0.01-5 parts by weight.

22. The method according to claim 8, wherein the crosslinking agent is calcium chloride, and/or a mixture of 1-ethyl-3-(3-dimethyl aminopropyl) carbodiimide and N-hydroxysuccinimide.
